(19) United States
(12) Patent Application Publication
(10) Pub. No.: US 2024/0007207 A1
(43) Pub. Date: Jan. 4, 2024

(54) ADAPTIVE CONFIGURATION OF MEASUREMENT GAP USAGE

(71) Applicant: Apple Inc., Cupertino, CA (US)

(72) Inventors: Yuanye Wang, San Jose, CA (US); Ahmad Rezazadehreyhani, San Jose, CA (US); Amir Aminzadeh Gohari, Sunnyvale, CA (US); Jie Cui, San Jose, CA (US); Marek Gil, San Diego, CA (US)

(73) Assignee: Apple Inc., Cupertino, CA (US)

(21) Appl. No.: 18/216,073

(22) Filed: Jun. 29, 2023

Related U.S. Application Data
(60) Provisional application No. 63/358,005, filed on Jul. 1, 2022.

(51) Int. Cl. H04B 17/336; H04B 17/318

(52) U.S. Cl. CPC H04B 17/336; H04B 17/328

(57) ABSTRACT

The present application relates to devices and components including apparatus, systems, and methods for measurement gap usage in wireless communication systems.

### CROSS-REFERENCE TO RELATED APPLICATIONS

This application claims the benefit of U.S. Provisional Application No. 63/358,005, filed on Jul. 1, 2022, which is incorporated by reference.

### BACKGROUND

Measurement gap configurations are provided in existing Third Generation Partnership Project (3GPP) networks.

### BRIEF DESCRIPTION OF THE DRAWINGS

FIG. 1 illustrates a network environment in accordance with some embodiments.

FIG. 2 illustrates a network environment in accordance with some embodiments.

FIG. 3 shows a table that describes a time budget for gap-based inter-frequency neighbor cell measurement in accordance with some embodiments.

FIG. 4 shows an example of an implementation of a technique for adapting a measurement gap usage ratio in accordance with some embodiments.

FIGS. 5A-5C show examples of relations between scheduling rate and various factors in accordance with some embodiments.

FIG. 6 shows a plot of a relation between serving cell quality and target measurement gap usage ratio in accordance with some embodiments.

FIG. 7 depicts an example of measurement gap usage patterns in accordance with some embodiments.

FIG. 8 illustrates an operational flow/algorithmic structure in accordance with some embodiments.

FIG. 9 illustrates an operational flow/algorithmic structure in accordance with some embodiments.

FIG. 10 illustrates an operational flow/algorithmic structure in accordance with some embodiments.

FIG. 11 illustrates beamforming components of a device in accordance with some embodiments.

FIG. 12 illustrates a user equipment in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). For the purposes of the present document, the phrase “A is based on B” means “A is based on at least B.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

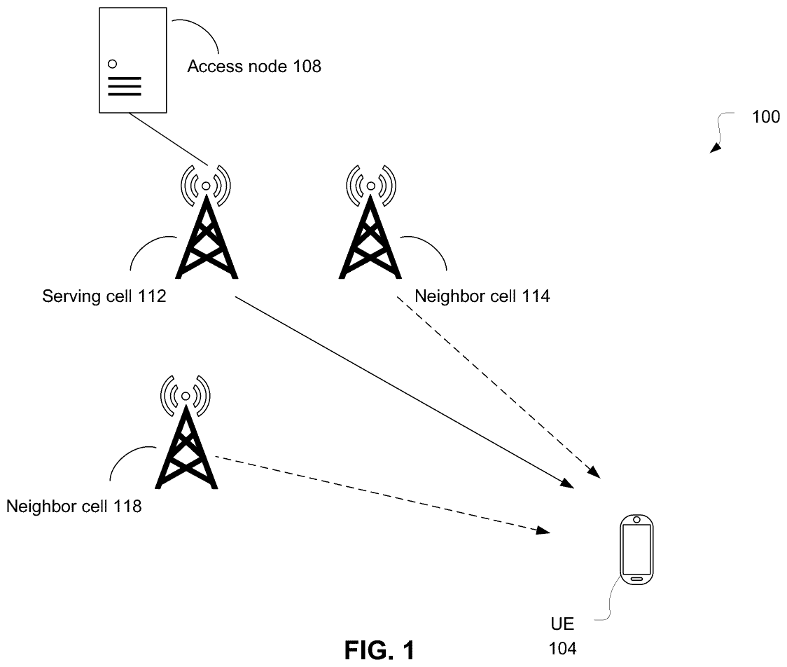

Techniques for measurement gap usage are described herein, especially with respect to a measurement gap usage ratio that is based on a measurement of at least one signal received by a UE from a serving cell. FIG. 1 illustrates a network environment 100 in accordance with some embodiments. The network environment 100 may include a UE 104 and an access node (or “base station”) 108. The access node 108 may provide one or more wireless serving cells 112, for example, 3GPP New Radio “NR” cells, through which the UE 104 may communicate with the access node 108 (e.g., over an NR-Uu interface).

The access node 108 may transmit information (for example, data and control signaling) in the downlink direction by mapping logical channels on the transport channels, and transport channels onto physical channels. The logical channels may transfer data between a radio link control (RLC) and media access control (MAC) layers; the transport channels may transfer data between the MAC and physical (PHY) layers; and the physical channels may transfer information across the air interface. The physical channels may include a physical broadcast channel (PBCH); a physical downlink shared channel (PDSCH); and a physical downlink control channel (PDCCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The access node (e.g., base station or gNB) 108 may also transmit various reference signals to the UE 104. A Reference Signal (RS) is a special signal that exists only at the PHY layer and is not for delivering any specific information (e.g., data), but whose purpose instead is to deliver a reference point for transmitted power. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel state information-reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization. For example, the SSBs and CSI-RSs may be measured by the UE 104 to determine the desired downlink beam pair for transmitting/receiving physical downlink control channel (PDCCH) and physical downlink shared channel (PDSCH) transmissions. The UE may use a Physical Uplink Control Channel (PUCCH) to transmit uplink control information (UCI) to the access node 108, including, for example, hybrid-automatic repeat request (HARQ) acknowledgements, scheduling requests, and periodic and semi-persistent channel state information (CSI) reports. The UE may also receive signals (e.g., SSBs, reference signals) transmitted by one or more other cells (neighbor cells) 114 and 118.

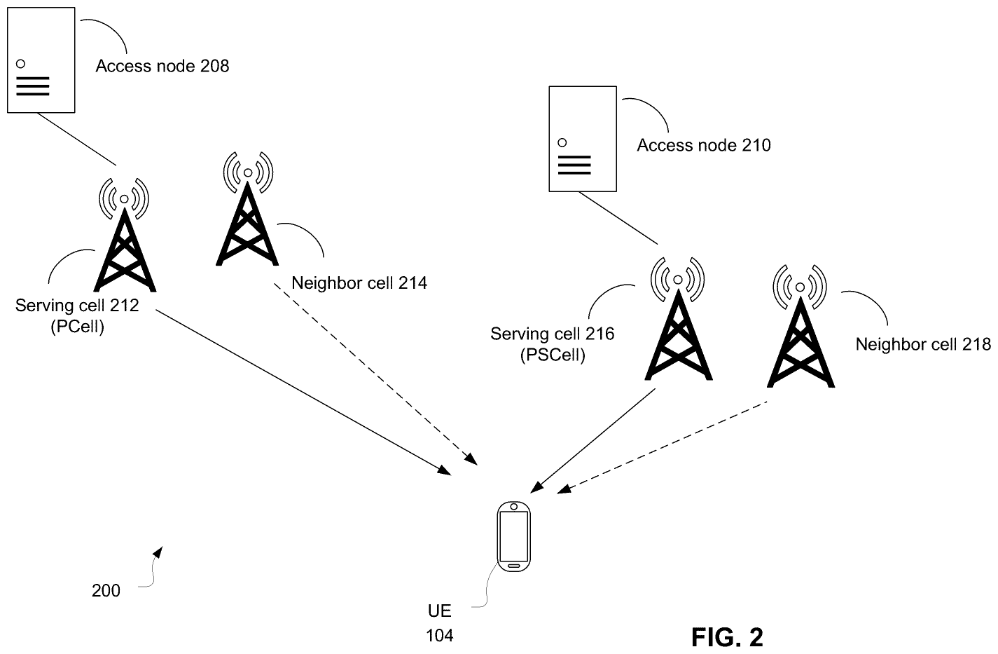

FIG. 2 illustrates a network environment 200 in accordance with some embodiments. In this example, access node 208 provides a serving cell 212 that communicates with the UE 104, and access node 210 provides a serving cell 216 that also communicates with the UE 104 over the same band (intra-band, either contiguous or non-contiguous), or over a different band (inter-band) and possibly a different frequency range, or using a different radio access technology (RAT). For Frequency Range 1 (e.g., below 7.225 GHz), a transmit antenna of the UE 104 is typically implemented as an omnidirectional antenna. For Frequency Range 2 (e.g., 24.250 GHz and above, also called mmWave), a transmit antenna of the UE 104 may be implemented as a panel having multiple antenna elements. For example, the multiple antenna elements of a panel may be driven as a phased array (e.g., to direct a beam in a desired direction).

The UE 104 may communicate with the access nodes 208 and 210 over an air interface compatible with 3GPP technical specifications such as those that define Fifth Generation (5G) NR system standards. Each of the access nodes 208 and 210 may be a next-generation—radio access network (NG-RAN) node that is coupled with a 5G core network. An NG-RAN node may be either a gNB to provide an NR user plane and control plane protocol terminations toward the UE 104 or an ng-eNB to provide evolved universal terrestrial radio access (E-UTRA) user plane and control plane protocol terminations toward the UE 104.

FIG. 2 illustrates an example of dual connectivity (DC), in which the UE 104 may exchange data traffic simultaneously with two different cell groups. In this example, access node 208 is the master node that provides the control plane connection to the core network, and access node 210 is the secondary node. The master node may be coupled with a 5G core (5GC) network via a backhaul connection that may support an NG-C interface. The serving cells provided by the master node (access node 208 in this example) comprise a master cell group (MCG), and the serving cells provided by the secondary node (access node 210 in this example) comprise a secondary cell group (SCG). Each of the MCG and SCG has a primary serving cell and, optionally, one or more secondary serving cells. A primary serving cell (also called special cell or spCell) of the MCG may be referred to as PCell, and a primary serving cell (spCell) of the SCG may be referred to as PSCell. In FIG. 2, serving cell 212 is the PCell and serving cell 216 is the PSCell. The UE 104 may also receive signals (e.g., SSBs, reference signals) transmitted by one or more neighbor cells 214 and 218.

The quality of the wireless connection between the network and the UE via the serving cell (e.g., the primary serving cell of a cell group, such as the PCell or the PSCell) may change over time. Most commonly, such a change arises due to movement of the UE, but other factors which may cause the quality of the wireless connection between the network and the UE via the serving cell to change over time include the appearance or movement of blockers or interferers or other changes in the network. If the wireless connection between the network and the UE is lost, it may be expensive (e.g., in terms of time and UE battery power) to restore it.

In order that the wireless connection between the network and the UE may be maintained, the network may configure the UE to perform and report measurements of its environment. In a wireless communications system (e.g., 3GPP LTE, 3GPP NR), a UE may perform search and measurement of signals (e.g., SSBs) received from cells with which the UE does not currently have a serving connection (also called “neighbor cells”). Specifically, the network may configure the UE to perform measurements of signals (e.g., SSBs) received from the serving cell and from each of one or more neighbor cells and to report serving cell quality and neighbor cell quality to the network based on such measurements (e.g., as specified in section 5.5 of the 3rd Generation Partnership Project (3GPP) Technical Specification (TS) 38.331 V16.8.0 (2022-05) entitled “5G; NR; Radio Resource Control (RRC); Protocol specification (3GPP TS 38.331 version 16.8.0 Release 16)” (3GPP, Valbonne, FR) (“TS 38.331”)). In a Dual Connectivity case, the network may configure the UE to perform such measurements and reporting for each of the respective primary serving cells (e.g., for the PCell and for the PSCell).

Based on the reported measurements, the network may configure a handover of the connection between the network and the UE from the current serving cell to another serving cell. For example, the network may select one of the neighbor cells to be the new serving cell. Such handovers may occur as the UE moves and/or as the network environment otherwise changes (e.g., as blockers move, as a serving cell and/or a neighbor cell moves, etc.).

Activities of search and measurement of signals received from neighbor cells as performed by a UE may conflict with the data communication activity as performed by the UE. For example, a UE typically has only one radio transceiver. Accordingly, for the time during which such a UE is performing measurements of a signal received from a neighbor cell, the UE does not receive data traffic from the serving cell or transmit data traffic to the serving cell. In such cases, the UE may perform neighbor cell measurement (e.g., measurement of a signal received from a neighbor cell) only in periods during which the network does not expect the UE to receive data traffic or to transmit data traffic.

To avoid conflicts between neighbor cell measurement activity by the UE and data traffic between the network and the UE, the network may provide a measurement gap configuration to the UE. This measurement gap configuration specifies a set of measurement gaps during which the network does not expect the UE to receive data traffic or to transmit data traffic. The network may pre-configure the UE with such a measurement gap configuration (e.g., by including the measurement gap configuration within the measurement configuration that specifies the measurements to be performed during the measurement gaps, as specified in section 5.5 of 3GPP TS 38.331).

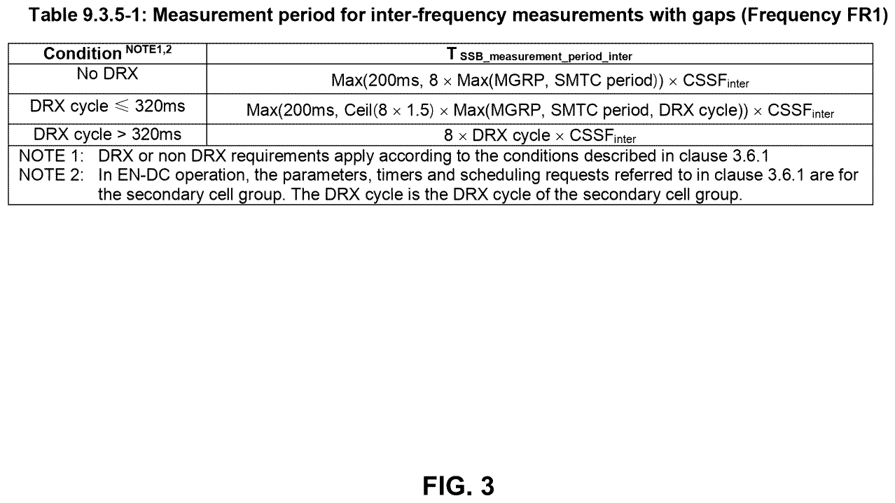

A measurement configuration provided by the network may require the UE to complete the specified neighbor cell measurements within some maximum time period. FIG. 3 shows a table from section 9.3.5 of 3GPP TS 38.133 (V16.11.0 (2022-05), entitled “5G; NR; Requirements for support of radio resource management (3GPP TS 38.133 version 16.11.0 Release 16)” (3GPP, Valbonne, FR) (“TS 38.133”) that describes a time budget for gap-based inter-frequency neighbor cell measurement in 5G NR. In this example, CSSF inter indicates a carrier-specific scaling factor; SMTC indicates an SSB-MeasurementTimingConfiguration (e.g., a window within which measurements of SSBs are to be performed, as specified in TS 38.331); and MGRP indicates a measurement gap repetition period (e.g., the periodicity at which the measurement gap repeats). In a particular example of no discontinuous reception (DRX), an SMTC window of 20 milliseconds, an MGRP of 20 milliseconds, and a CSSF equal to one, this table specifies a time budget for measurement of 200 milliseconds, or ten measurement gap occasions.

The 3GPP Technical Specifications that are currently in effect do not mandate how the UE must use the measurement gaps as configured by the network. It is possible that the UE may complete all of the neighbor cell measurements needed to satisfy the measurement configuration as specified by the network without using all of the measurement gaps provided by the measurement gap configuration. For example, with reference to the time budget described above, if the UE only needs three measurement iterations to achieve the accuracy requirement, then only three of the ten measurement gaps are needed to satisfy the minimum performance requirement. Using all ten measurement gaps would result in a neighbor cell measurement that is 233% faster than specified (e.g., (10/3)−1).

As an alternative to using all of the measurement gaps for neighbor cell measurement, the UE may be configured to use only the necessary amount of measurement gaps to guarantee a sufficient search and measurement performance. In such cases, it may be advantageous for the UE to turn off (e.g., to power down) the radio-frequency (RF) receiver during one or more of the unused measurement gaps (e.g., to save power) and/or to perform another action during one or more of the unused measurement gaps. In a configuration for a period of ten measurement gaps as described above with reference to FIG. 3, for example, the UE could use only three measurement gaps for neighbor cell measurement and stay in a low-power mode for the remaining seven measurement gaps. Alternatively, one or more of the remaining measurement gaps could be used for other purposes. For example, it may be desired for the UE to transmit another signal during one or more of the unused measurement gaps. In one such example, it may be desired for the UE to transmit a signal on a physical random access channel (PRACH) during one or more of the unused measurement gaps (e.g., to request an uplink allocation from a base station).

Techniques for adapting a measurement gap usage ratio are described herein, especially with respect to a measurement gap usage ratio that is based on a measurement of at least one signal received by a UE from a serving cell (e.g., a measurement gap usage ratio that is based on serving cell quality). Such a technique may be implemented to achieve, for example, a desired tradeoff between measurement performance and power consumption.

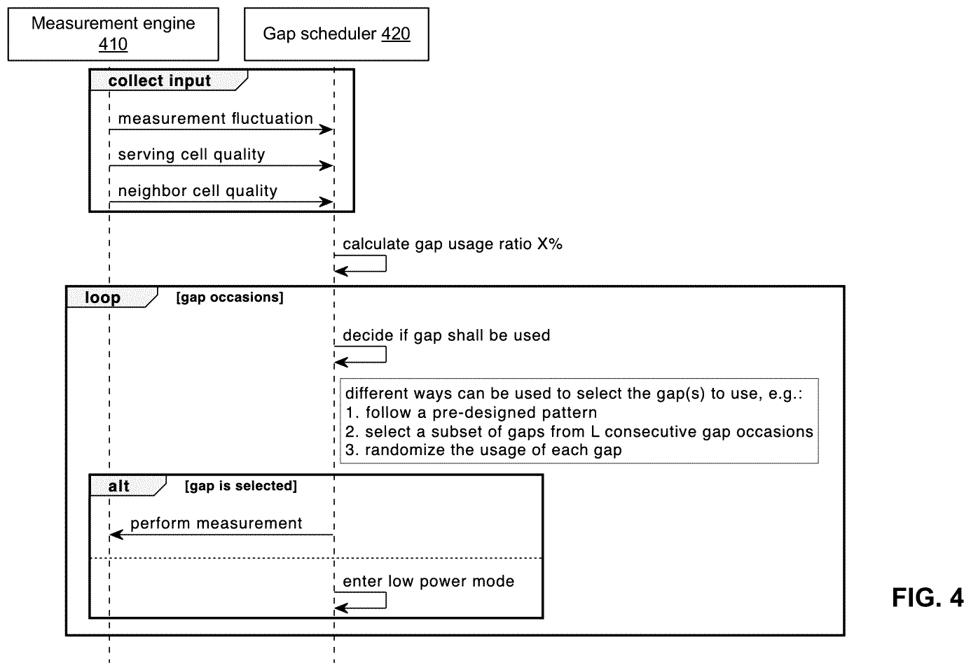

A technique for adapting a measurement gap usage ratio may include adjusting measurement gap usage based on factors for measurement gap usage optimization. FIG. 4 shows an example of an implementation of such a technique as may be performed by a measurement engine 410 and a gap scheduler 420 of a UE (e.g., UE 104). Such a technique may include collecting input of the factors (e.g., by the measurement engine 410), calculating a target measurement gap usage ratio (e.g., by the gap scheduler 420), and selecting a measurement gap for neighbor cell measurement based on the target measurement gap usage ratio (e.g., by the gap scheduler 420). Measurement engine 410 and gap scheduler 420 may be implemented, for example, as modules executing on a baseband processor of a UE (e.g., UE 104).

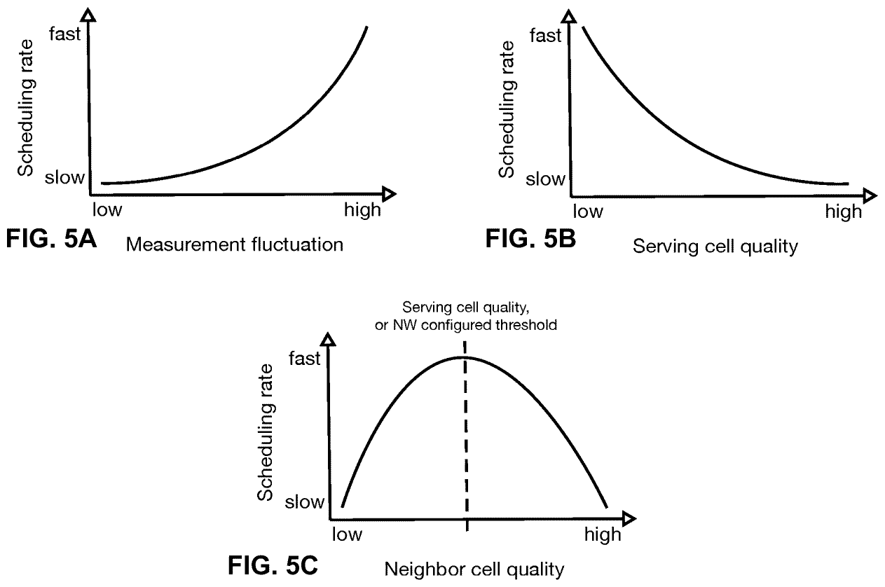

One factor that may be used for measurement gap usage optimization is fluctuation over time in the measurement of the signal received from the serving cell or in the measurement of the signal received from each of one or more neighbor cells. If the results of successive measurements of a signal across time (e.g., by measurement engine 410) remain similar, then it may be expected that the UE can measure less frequently and yet still be able to capture changes in the condition of the signal. If the results of successive measurements of a signal across time are dissimilar, however, then it may be desired for the UE (e.g., for measurement engine 410) to measure more frequently in order to capture changes in the condition of the signal. Accordingly, the target measurement gap usage ratio (e.g., the rate at which measurements are scheduled) may be calculated (e.g., by gap scheduler 420) such that the ratio increases in response to an increase in a fluctuation over time in the measurement (e.g., by measurement engine 410) of the signal received from the serving cell or in the measurement (e.g., by measurement engine 410) of the signal received from each of one or more neighbor cells. FIG. 5A shows one example of such a relation between scheduling rate and measurement fluctuation.

Another factor that may be used for measurement gap usage optimization (e.g., in addition to, or in the alternative to, measurement fluctuation as described above) is serving cell quality. If serving cell quality is high, it may be expected that a handover from the serving cell to a neighbor cell is unlikely to occur, so that the UE may take a longer period to detect a neighbor cell that is suitable for handover (e.g., so that the UE (e.g., measurement engine 410) may perform neighbor cell measurements less frequently). If serving cell quality is low, however, it may be desired for the UE to detect a suitable neighbor cell more quickly, as it may be expected that the network will ask the UE to handover to the newly detected neighbor cell soon. Accordingly, the target measurement gap usage ratio (e.g., the rate at which measurements are scheduled) may be calculated (e.g., by gap scheduler 420) such that the ratio increases in response to an decrease in serving cell quality. FIG. 5B shows one example of such a relation between scheduling rate and serving cell quality.

A further factor that may be used for measurement gap usage optimization (e.g., in addition to, or in the alternative to, one or both of measurement fluctuation or serving cell quality as described above) is neighbor cell quality. When the quality of a neighbor cell is very poor, the neighbor cell is not a viable candidate for handover, and measurements of the neighbor cell (e.g., by measurement engine 410) may be performed less frequently. When neighbor cell quality reaches a level at which it is comparable to serving cell quality (or, alternatively, to a threshold that may be configured by the network), the likelihood that a handover will occur approaches its peak, and it may be desired for the UE (e.g., for measurement engine 410) to perform neighbor cell measurements more frequently to trigger a handover in time. When neighbor cell quality is significantly better than serving cell quality (or is significantly better than the network-configured threshold), measurements of the neighbor cell (e.g., by measurement engine 410) may again be performed less frequently, as even an inaccurate measurement result (e.g., as may be produced by a slow measurement rate) may still serve the purpose of handover trigger. In such case, the fact that the network has not yet requested a handover to the neighbor cell, even though its quality exceeds that of the serving cell, may indicate that handover is unlikely to occur. FIG. 5C shows one example of such a relation between scheduling rate and neighbor cell quality.

The UE (e.g., measurement engine 410) may be configured to obtain a neighbor cell quality factor based on measurements of signals received from each of two or more neighbor cells. For example, the UE (e.g., measurement engine 410) may be configured to calculate the neighbor cell quality factor as the highest among the individual neighbor cell qualities, or as an average of the highest two or three among the individual neighbor cell qualities, etc. Likewise, the UE (e.g., measurement engine 410) may be configured to obtain a measurement fluctuation factor based on measurements of a signal received from the serving cell or based on measurements of signals received from each of two or more cells (e.g., as an average of a fluctuation over time of the serving cell quality and a fluctuation over time of the neighbor cell quality). It is noted that the diagrams shown in FIGS. 5A-5C are for illustration purposes only, and that the respective mappings of the different factors as discussed above to corresponding scheduling rate requirements may differ from (e.g., may be performed according to different equations than) the particular mappings illustrated in these figures.

The UE (e.g., gap scheduler 420) may proceed to calculate a target measurement gap usage ratio based on one or more collected factors (e.g., one or more of measurement fluctuation, serving cell quality, or neighbor cell quality as described above). For example, the UE (e.g., gap scheduler 420) may calculate the target measurement gap usage ratio according to a particular one of such factors (e.g., serving cell quality), or as a weighted combination of two or more such factors. A minimum ratio of 0% indicates that neighbor cell measurement is completely disabled (e.g., that none of the measurement gaps indicated by the measurement gap configuration will be used for neighbor cell measurement), and a maximum ratio of 100% indicates that all of the measurement gaps will be used for neighbor cell measurement (e.g., by measurement engine 410). A ratio between 0 and 100% indicates that some of the measurement gaps will be used for neighbor cell measurement (e.g., by measurement engine 410) and that the remaining measurement gaps will not be used for neighbor cell measurement (e.g., may be left unused for power saving or may be used for another purpose).

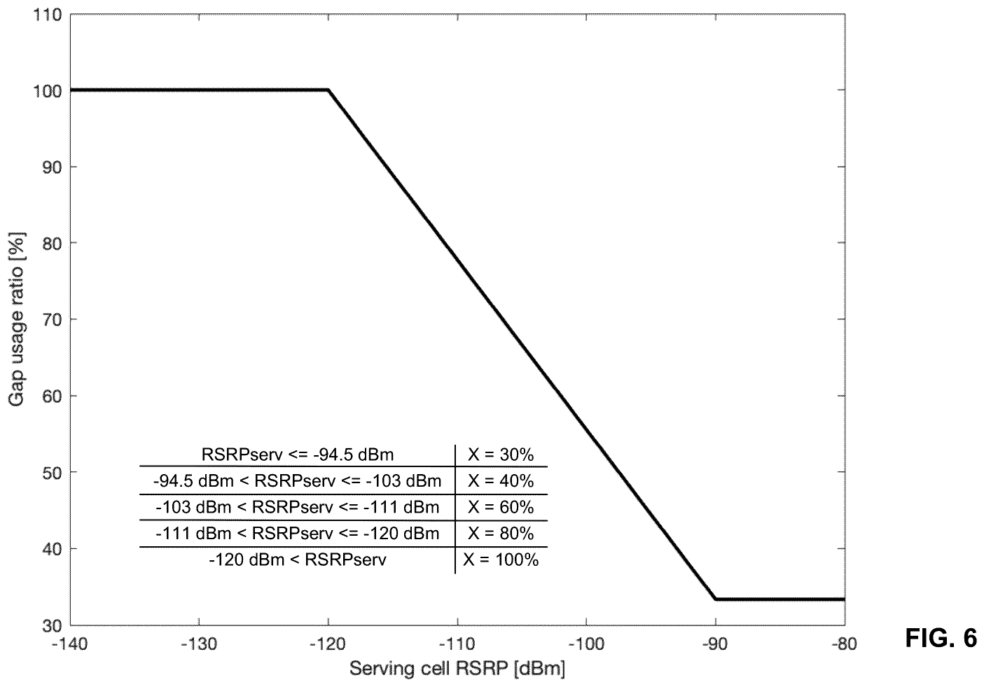

The plot in FIG. 6 shows an example according to which a target measurement gap usage ratio X that is based on serving cell quality (e.g., serving cell RSRP or ‘RSRPsery’) may be calculated. This example specifies a minimum measurement gap usage ratio of Xmin=30%; a minimum RSRP threshold RSRPmin of −120dB (e.g., X=100% for serving cell RSRP<=RSRPmin); a maximum RSRP threshold RSRPmax of −90dB (e.g., X=Xmin for serving cell RSRP>=RSRPmax); and X=Xmin+(RSRPmax−RSRPserv)/(RSRPmax−RSRPmin)*(1−Xmin) for serving cell RSRP between RSRPmin and RSRPmax. The table in FIG. 6 shows one example of an assignment of ranges of RSRPsery to values of target measurement gap usage ratio X according to a relation as shown in the plot.

After calculating the target measurement gap usage ratio, the UE (e.g., gap scheduler 420) may proceed to select individual measurement gaps for neighbor cell measurement. The UE may be configured to perform the selection of which measurement gap or gaps to use, in order to achieve the target measurement gap usage ratio, in any of several different ways. In one example, the UE is configured to select individual measurement gaps for neighbor cell measurement according to a pre-designed pattern (e.g., a binary pattern, a bitmap pattern), where the pattern may be selected from among a plurality of pre-designed patterns according to the target measurement gap usage ratio.

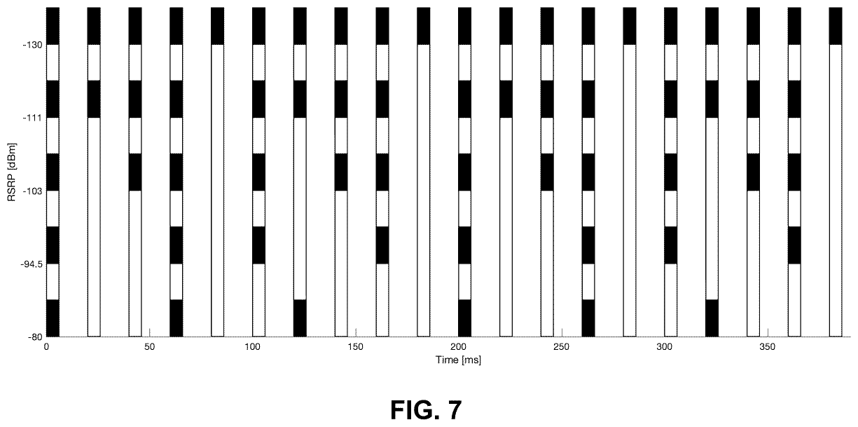

FIG. 7 depicts an example of a set of five measurement gap usage patterns in which black rectangles indicate measurement gaps that are used for neighbor cell measurement. This example corresponds to the relation between serving cell RSRP RSRPsery and target measurement gap usage ratio X as shown in the table of FIG. 6, such that either 30%, 40%, 60%, 80%, or 100% of the measurement gaps are used for neighbor cell measurement, according to the value of RSRPserv.

In another example, the UE (e.g., gap scheduler 420) is configured to select individual measurement gaps for neighbor cell measurement by selecting a subset M of measurement gaps from among L consecutive measurement gap occasions, where M/L is at least substantially equal to the target measurement gap usage ratio (e.g., M/L is within 5% or 10% of the target measurement gap usage ratio). In a further example, the UE's usage of each measurement gap is randomized. For example, the UE (e.g., gap scheduler 420) may be configured to generate, for each of one or more of the measurement gaps, a corresponding random number, and to determine whether to use each measurement gap for neighbor cell measurement by comparing the corresponding random number to a threshold that is based on the target measurement gap usage ratio (e.g., to use the measurement gap for neighbor cell measurement if the corresponding random number (in a range of from zero to one) does not exceed the target measurement gap usage ratio).

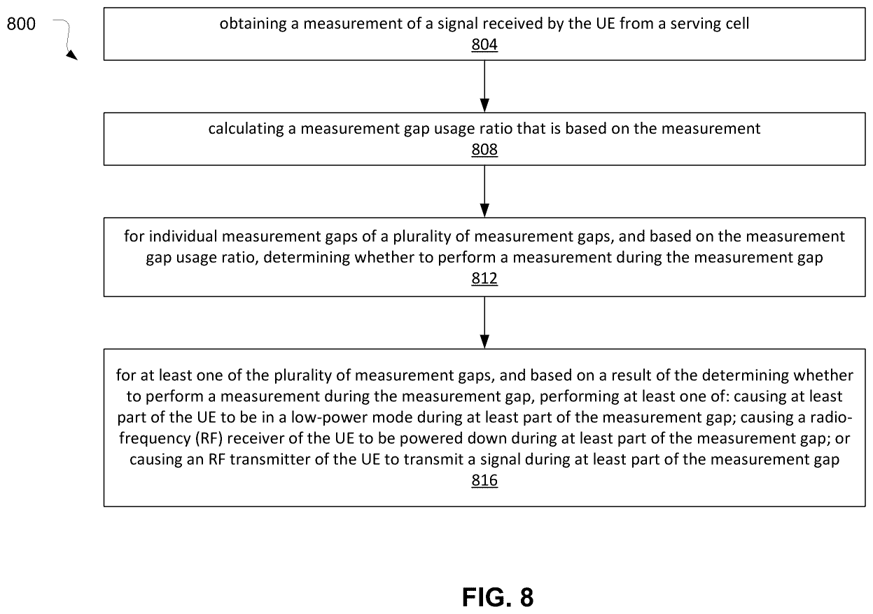

FIG. 8 illustrates an operation flow/algorithmic structure 800 in accordance with some embodiments. The operation flow/algorithmic structure 800 may be performed or implemented by a UE such as, for example, UE 104 or UE 1200; or components thereof, for example, baseband processor 1204A.

The operation flow/algorithmic structure 800 may include, at 804, obtaining a measurement of a signal received by the UE from a serving cell. The measurement may be, for example, a serving cell quality measurement that indicates at least one of a reference signal received power (RSRP), reference signal received quality (RSRQ), or signal-to-interference-plus-noise ratio (SINR) of the signal received by the UE from the serving cell.

The operation flow/algorithmic structure 800 may further include, at 808, calculating a measurement gap usage ratio that is based on the measurement. In one example, the measurement gap usage ratio is based on a fluctuation of the measurement. The measurement gap usage ratio may be inversely related to the serving cell quality measurement. The measurement gap usage ratio may be based on a neighbor cell quality measurement that is based on a plurality of neighbor cell measurements, and each of the neighbor cell measurements may be a measurement of a signal received by the UE from a respective one of a plurality of neighbor cells. In such case, the measurement gap usage ratio may be inversely related to a difference between the serving cell quality measurement and the neighbor cell quality measurement. The measurement gap usage ratio may be inversely related to a difference between the neighbor cell quality measurement and a threshold value received by the UE from a base station.

The operation flow/algorithmic structure 800 may further include, at 812, for individual measurement gaps of a plurality of measurement gaps, and based on the measurement gap usage ratio, determining whether to perform a measurement (e.g., a neighbor cell measurement) during the measurement gap.

The operation flow/algorithmic structure 800 may further include, at 816, for at least one of the plurality of measurement gaps, and based on a result of the determining whether to perform a measurement during the measurement gap, performing at least one of: causing at least part of the UE to be in a low-power mode during at least part of the measurement gap; causing an RF receiver of the UE to be powered down during at least part of the measurement gap; or causing an RF transmitter of the UE to transmit a signal during at least part of the measurement gap.

The operation flow/algorithmic structure 800 may include, based on the measurement gap usage ratio, selecting a pattern, and for the individual measurement gaps of the plurality of measurement gaps, the determining whether to perform a measurement during the measurement gap may be based on the pattern.

The operation flow/algorithmic structure 800 may include, for the individual measurement gaps of the plurality of measurement gaps: generating a random number; and the determining whether to perform a measurement during the measurement gap may include comparing the random number to a threshold that is based on the measurement gap usage ratio.

The operation flow/algorithmic structure 800 may include, for at least one of the plurality of measurement gaps, and based on the result of the determining whether to perform a measurement during the measurement gap, causing the UE to transmit a signal on a PRACH during at least part of the measurement gap.

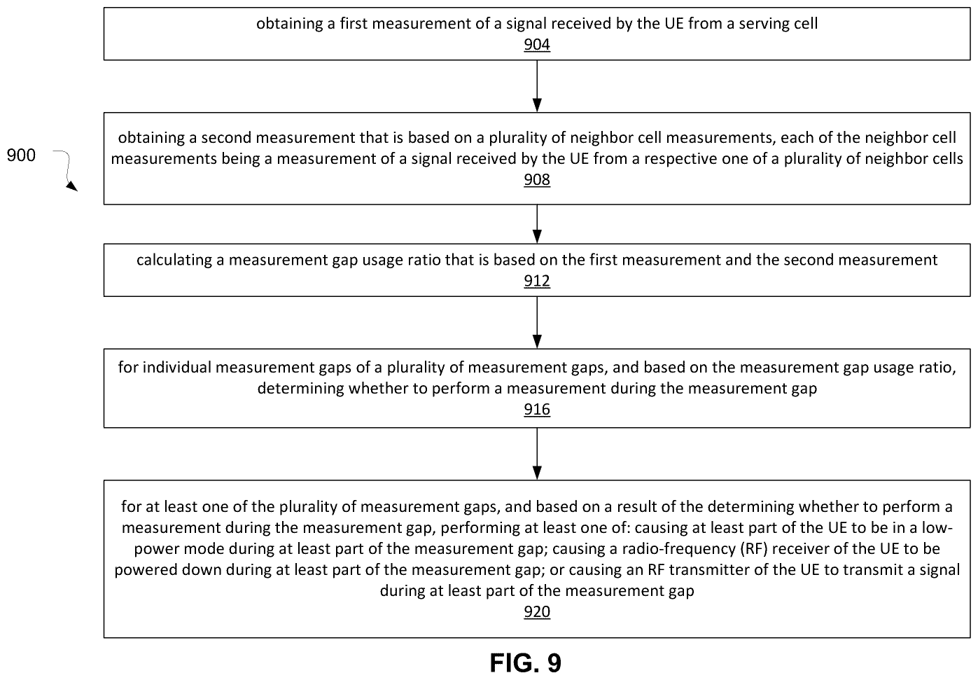

FIG. 9 illustrates an operation flow/algorithmic structure 900 in accordance with some embodiments. The operation flow/algorithmic structure 900 may be performed or implemented by a UE such as, for example, UE 104 or UE 1200; or components thereof, for example, baseband processor 1204A.

The operation flow/algorithmic structure 900 may include, at 904, obtaining a first measurement of a signal received by the UE from a serving cell. The measurement may be, for example, a serving cell quality measurement that indicates at least one of a RSRP, RSRQ, or SINR of the signal received by the UE from the serving cell.

The operation flow/algorithmic structure 900 may further include, at 908, obtaining a second measurement that is based on a plurality of neighbor cell measurements, each of the neighbor cell measurements being a measurement of a signal received by the UE from a respective one of a plurality of neighbor cells.

The operation flow/algorithmic structure 900 may further include, at 912, calculating a measurement gap usage ratio that is based on the first measurement and the second measurement. In one example, the measurement gap usage ratio is based on a fluctuation of at least one among the first measurement and the second measurement. The measurement gap usage ratio may be inversely related to the serving cell quality measurement. The measurement gap usage ratio may be inversely related to a difference between the first measurement and the second measurement. The measurement gap usage ratio may be inversely related to a difference between the second measurement and a threshold value received by the UE from a base station.

The operation flow/algorithmic structure 900 may further include, at 916, for individual measurement gaps of a plurality of measurement gaps, and based on the measurement gap usage ratio, determining whether to perform a measurement (e.g., a neighbor cell measurement) during the measurement gap.

The operation flow/algorithmic structure 900 may further include, at 918, for at least one of the plurality of measurement gaps, and based on a result of the determining whether to perform a measurement during the measurement gap: causing at least part of the UE to be in a low-power mode during at least part of the measurement gap; causing an RF receiver of the UE to be powered down during at least part of the measurement gap; or causing an RF transmitter of the UE to transmit a signal during at least part of the measurement gap.

The operation flow/algorithmic structure 900 may include, based on the measurement gap usage ratio, selecting, based on the measurement gap usage ratio, a pattern from among a plurality of patterns, and for the individual measurement gaps of the plurality of measurement gaps, the determining whether to perform a measurement during the measurement gap may be based on the pattern.

The operation flow/algorithmic structure 900 may include, for the individual measurement gaps of the plurality of measurement gaps, generating a corresponding random number; and the determining whether to perform a measurement during the measurement gap may include comparing the corresponding random number to a threshold that is based on the measurement gap usage ratio.

The operation flow/algorithmic structure 900 may include, for at least one of the plurality of measurement gaps, and based on the result of the determining whether to perform a measurement during the measurement gap, causing the UE to transmit a signal on a PRACH during at least part of the measurement gap.

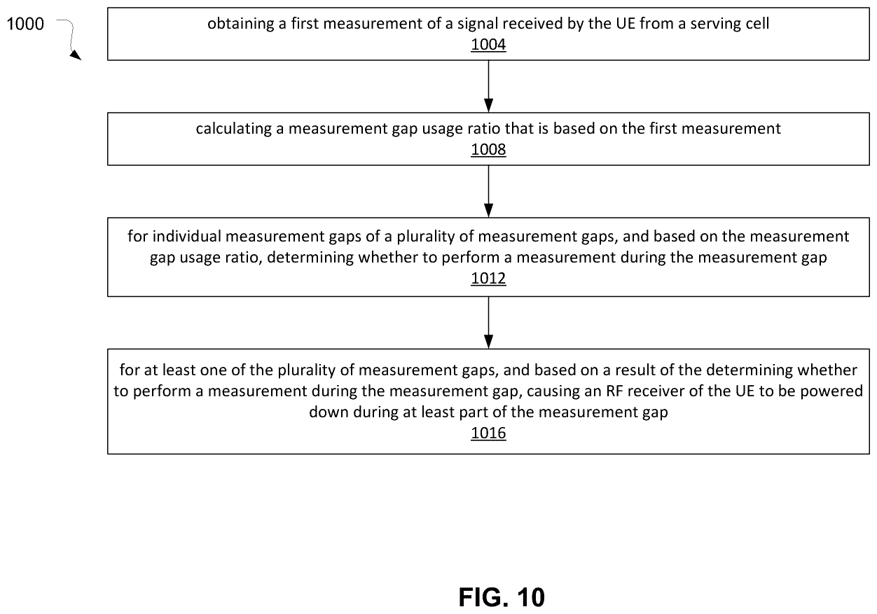

FIG. 10 illustrates an operation flow/algorithmic structure 1000 in accordance with some embodiments. The operation flow/algorithmic structure 1000 may be performed or implemented by a UE such as, for example, UE 104 or UE 1200; or components thereof, for example, baseband processor 1204A.

The operation flow/algorithmic structure 1000 may include, at 1004, obtaining a first measurement of a signal received by the UE from a serving cell. The first measurement may be, for example, a serving cell quality measurement that indicates at least one of a RSRP, RSRQ, or SINR of the signal received by the UE from the serving cell.

The operation flow/algorithmic structure 1000 may further include, at 1008, calculating a measurement gap usage ratio that is based on the first measurement. In one example, the measurement gap usage ratio is based on a fluctuation of the first measurement. The measurement gap usage ratio may be inversely related to the serving cell quality measurement. The measurement gap usage ratio may be based on a neighbor cell quality measurement that is based on a plurality of neighbor cell measurements, and each of the neighbor cell measurements may be a measurement of a signal received by the UE from a respective one of a plurality of neighbor cells. In such case, the measurement gap usage ratio may be inversely related to a difference between the serving cell quality measurement and the neighbor cell quality measurement. The measurement gap usage ratio may be inversely related to a difference between the neighbor cell quality measurement and a threshold value received by the UE from a base station.

The operation flow/algorithmic structure 1000 may further include, at 1012, for individual measurement gaps of a plurality of measurement gaps, and based on the measurement gap usage ratio, determining whether to perform a measurement (e.g., a neighbor cell measurement) during the measurement gap.

The operation flow/algorithmic structure 1000 may further include, at 1016, for at least one of the plurality of measurement gaps, and based on a result of the determining whether to perform a measurement during the measurement gap, causing an RF receiver of the UE to be powered down during at least part of the measurement gap.

The operation flow/algorithmic structure 1000 may include, based on the measurement gap usage ratio, selecting, based on the measurement gap usage ratio, a bitmap pattern, and for the individual measurement gaps of the plurality of measurement gaps, the determining whether to perform a measurement during the measurement gap may be based on a corresponding value of the bitmap pattern.

The operation flow/algorithmic structure 1000 may include, for the individual measurement gaps of the plurality of measurement gaps: generating a corresponding random number; and the determining whether to perform a measurement during the measurement gap may include comparing the corresponding random number to a threshold that is based on the measurement gap usage ratio.

The operation flow/algorithmic structure 1000 may include, for at least one of the plurality of measurement gaps, and based on the result of the determining whether to perform a measurement during the measurement gap, causing the UE to transmit a signal on a PRACH during at least part of the measurement gap.

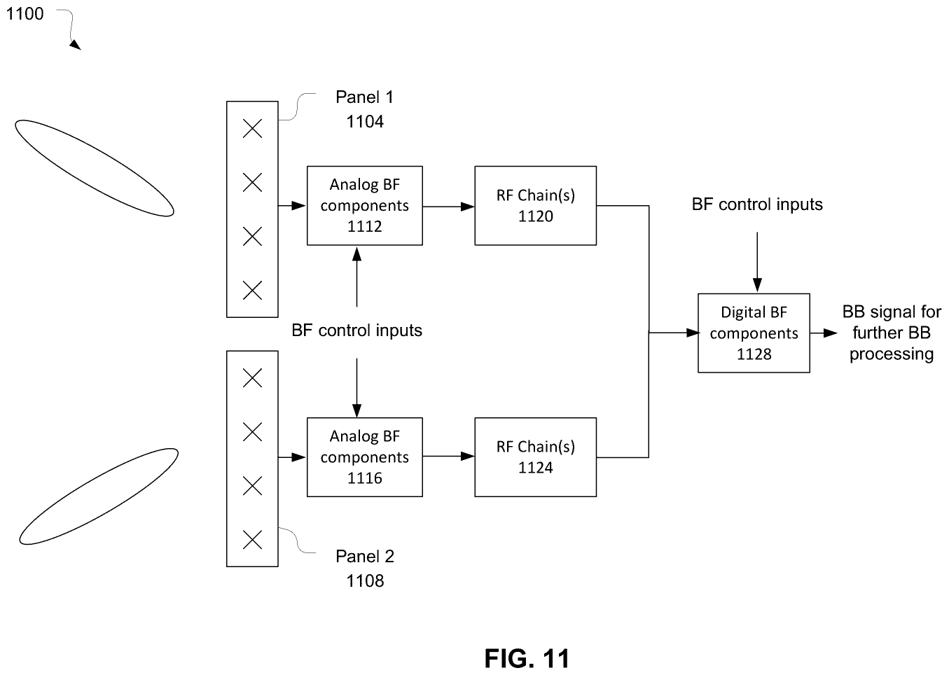

FIG. 11 illustrates receive components 1100 of a device in accordance with some embodiments. The device may be the UE 104 or another UE. The receive components 1100 may include a first antenna panel, panel 1 1104, and a second antenna panel, panel 2 1108. Each antenna panel may include a number of antenna elements.

The antenna panels may be coupled to respective analog beamforming (BF) components. For example, panel 1 1104 may be coupled with analog BF components 1112 and panel 2 1108 may be coupled with analog BF components 1116.

The analog BF components may be coupled with one or more radio-frequency (RF) chains. For example, analog BF components 1112 may be coupled with one or more RF chains 1120 and analog BF components 1116 may be coupled with one or more RF chains 1124. The RF chains may amplify a receive analog RF signal, downconvert the RF signal to baseband, and convert the analog baseband signal to a digital baseband signal, which may be provided to digital BF components 1128. The digital BF components 1128 may provide a baseband (BB signal) for further BB processing.

In various embodiments, control circuitry, which may reside in a baseband processor, may provide BF weights to the analog/digital BF components to provide a receive beam at respective antenna panels. These BF weights may be determined by the control circuitry based on received reference signals and corresponding QCL/TCI information as described herein. In some embodiments, the BF weights may be phase-shift values provided to phase shifters of the analog BF components 1112 or complex weights provided to the digital BF components 1128. In some embodiments, the BF components and antenna panels may operate together to provide a dynamic phased-array that is capable of directing the beams in the desired direction.

In various embodiments, beamforming may include analog, only digital, or a hybrid analog-digital beamforming. Digital beamforming may utilize separate RF chains that respectively correspond to the antenna elements.

While the beamforming components 1100 describe receive beamforming, other embodiments may include beamforming components that perform transmit beamforming in analogous manners.

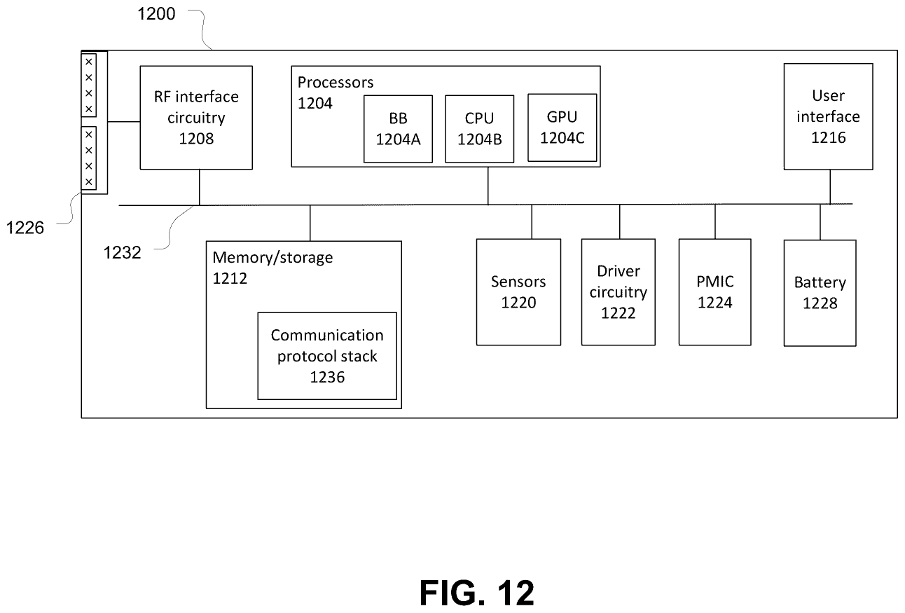

FIG. 12 illustrates a UE 1200 in accordance with some embodiments. The UE 1200 may be similar to and substantially interchangeable with UE 104 of FIGS. 1 and 2.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, phased array antennas, etc. The antenna 1226 may have one or more panels designed for specific frequency bands including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200 including DRX as discussed herein.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method of operating a UE, the method comprising obtaining a measurement of a signal received by the UE from a serving cell; calculating a measurement gap usage ratio that is based on the measurement; and for individual measurement gaps of a plurality of measurement gaps, and based on the measurement gap usage ratio, determining whether to perform a measurement during the measurement gap. The method further comprises, for at least one of the plurality of measurement gaps, and based on a result of the determining whether to perform a measurement during the measurement gap, performing at least one of: causing at least part of the UE to be in a low-power mode during at least part of the measurement gap; causing an RF receiver of the UE to be powered down during at least part of the measurement gap; or causing an RF transmitter of the UE to transmit a signal during at least part of the measurement gap.

Example 2 includes the method of Example 1 or some other example herein, wherein the measurement gap usage ratio is based on a fluctuation of the measurement.

Example 3 includes the method of any of Examples 1 or 2 or some other example herein, wherein the measurement is a serving cell quality measurement that indicates at least one of a RSRP, RSRQ, or SINR of the signal received by the UE from the serving cell.

Example 4 includes the method of Example 3 or some other example herein, wherein the measurement gap usage ratio is inversely related to the serving cell quality measurement.

Example 5 includes the method of any of Examples 3 to 4 or some other example herein, wherein the measurement gap usage ratio is based on a neighbor cell quality measurement that is based on a plurality of neighbor cell measurements, and each of the neighbor cell measurements is a measurement of a signal received by the UE from a respective one of a plurality of neighbor cells.

Example 6 includes the method of Example 5 or some other example herein, wherein the measurement gap usage ratio is inversely related to a difference between the serving cell quality measurement and the neighbor cell quality measurement.

Example 7 includes the method of any of Examples 5 and 6 or some other example herein, wherein the measurement gap usage ratio is inversely related to a difference between the neighbor cell quality measurement and a threshold value received by the UE from a base station.

Example 8 includes the method of any of Examples 1 to 4 or some other example herein, wherein the measurement gap usage ratio is based on a measurement of a signal received by the UE from a neighbor cell that is different than the serving cell.

Example 9 includes the method of any of Examples 1 to 8 or some other example herein, wherein the method comprises, based on the measurement gap usage ratio, selecting a pattern; and for the individual measurement gaps of the plurality of measurement gaps, the determining whether to perform a measurement during the measurement gap is based on the pattern.

Example 10 includes the method of any of Examples 1 to 8 or some other example herein, wherein the method comprises, for the individual measurement gaps of the plurality of measurement gaps: generating a random number; and the determining whether to perform a measurement during the measurement gap includes comparing the random number to a threshold that is based on the measurement gap usage ratio.

Example 11 includes the method of any of Examples 1 to 10 or some other example herein, wherein the method comprises, for at least one of the plurality of measurement gaps, and based on the result of the determining whether to perform a measurement during the measurement gap, causing the UE to transmit a signal on a PRACH during at least part of the measurement gap.

Example 12 includes a method of causing a UE to obtain a first measurement of a signal received by the UE from a serving cell; obtain a second measurement that is based on a plurality of neighbor cell measurements, each of the neighbor cell measurements being a measurement of a signal received by the UE from a respective one of a plurality of neighbor cells; calculate a measurement gap usage ratio that is based on the first measurement and the second measurement; and for individual measurement gaps of a plurality of measurement gaps, and based on the measurement gap usage ratio, determine whether to perform a measurement during the measurement gap. For at least one of the plurality of measurement gaps, and based on a result of the determination whether to perform a measurement during the measurement gap, the method further includes causing at least part of the UE to be in a low-power mode during at least part of the measurement gap; causing an RF receiver of the UE to be powered down during at least part of the measurement gap; or causing an RF transmitter of the UE to transmit a signal during at least part of the measurement gap.

Example 13 includes the method of Example 12 or some other example herein, wherein the first measurement is a serving cell quality measurement that indicates at least one of a RSRP, RSRQ, or SINR of the signal received by the UE from the serving cell.

Example 14 includes the method of any of Examples 12 and 13 or some other example herein, wherein the measurement gap usage ratio is inversely related to a difference between the first measurement and the second measurement.

Example 15 includes the method of any of Examples 12 to 14 or some other example herein, wherein the method further includes causing the UE to select, based on the measurement gap usage ratio, a pattern from among a plurality of patterns; and for the individual measurement gaps of the plurality of measurement gaps, the determining whether to perform a measurement during the measurement gap is based on the pattern.

Example 16 includes the method of any of Examples 12 to 14 or some other example herein, wherein the method further includes causing the UE to generate, for the individual measurement gaps of the plurality of measurement gaps, a corresponding random number; and the determining whether to perform a measurement during the measurement gap includes comparing the corresponding random number to a threshold that is based on the measurement gap usage ratio.

Example 17 includes the method of any of Examples 12 to 16 or some other example herein, wherein, for at least one of the plurality of measurement gaps, and based on the result of the determining whether to perform a measurement during the measurement gap, the method further includes causing the UE to transmit a signal on a PRACH during at least part of the measurement gap.

Example 18 includes a method of operating a UE, the method comprising obtaining a first measurement of a signal received by the UE from a serving cell; calculating a measurement gap usage ratio that is based on the first measurement; and for individual measurement gaps of a plurality of measurement gaps, and based on the measurement gap usage ratio, determining whether to perform a measurement during the measurement gap. For at least one of the plurality of measurement gaps, and based on a result of the determining whether to perform a measurement during the measurement gap, the method further includes causing an RF receiver of the UE to be powered down during at least part of the measurement gap.

Example 19 includes the method of Example 18 or some other example herein, wherein the method includes selecting, based on the measurement gap usage ratio, a bitmap pattern; and for the individual measurement gaps of the plurality of measurement gaps, the determining whether to perform a measurement during the measurement gap is based on a corresponding value of the bitmap pattern.

Example 20 includes the method of Example 18 or some other example herein, wherein, for the individual measurement gaps of the plurality of measurement gaps: the method includes generating a corresponding random number; and the determining whether to perform a measurement during the measurement gap includes comparing the corresponding random number to a threshold that is based on the measurement gap usage ratio.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof

Example 26 may include a signal as described in or related to any of examples 1-20, or portions or parts thereof

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, TE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof

Example 31 may include a computer program comprising instructions, wherein execution of the program by a processing element is to cause the processing element to carry out the method, techniques, or process as described in or related to any of examples 1-20, or portions thereof

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a user equipment (UE), the method comprising:
obtaining a measurement of a signal received by the UE from a serving cell;
calculating a measurement gap usage ratio that is based on the measurement; and
for individual measurement gaps of a plurality of measurement gaps, and based on the measurement gap usage ratio, determining whether to perform a measurement during the measurement gap,
wherein the method further comprises, for at least one of the plurality of measurement gaps, and based on a result of the determining whether to perform a measurement during the measurement gap, performing at least one of:
causing at least part of the UE to be in a low-power mode during at least part of the measurement gap;
causing a radio-frequency (RF) receiver of the UE to be powered down during at least part of the measurement gap; or
causing an RF transmitter of the UE to transmit a signal during at least part of the measurement gap.

2. The method of claim 1, wherein the measurement gap usage ratio is based on a fluctuation of the measurement.

3. The method of claim 1, wherein the measurement is a serving cell quality measurement that indicates at least one of a reference signal received power (RSRP), reference signal received quality (RSRQ), or signal-to-interference-plus-noise ratio (SINR) of the signal received by the UE from the serving cell.

4. The method of claim 3, wherein the measurement gap usage ratio is inversely related to the serving cell quality measurement.

5. The method of claim 3, wherein:
the measurement gap usage ratio is based on a neighbor cell quality measurement that is based on a plurality of neighbor cell measurements, and
each of the neighbor cell measurements is a measurement of a signal received by the UE from a respective one of a plurality of neighbor cells.

6. The method of claim 5, wherein the measurement gap usage ratio is inversely related to a difference between the serving cell quality measurement and the neighbor cell quality measurement.

7. The method of claim 5, wherein the measurement gap usage ratio is inversely related to a difference between the neighbor cell quality measurement and a threshold value received by the UE from a base station.

8. The method of claim 1, wherein the measurement gap usage ratio is based on a measurement of a signal received by the UE from a neighbor cell that is different than the serving cell.

9. The method of claim 1, wherein:
the method comprises, based on the measurement gap usage ratio, selecting a pattern; and
for the individual measurement gaps of the plurality of measurement gaps, the determining whether to perform a measurement during the measurement gap is based on the pattern.

10. The method of claim 1, wherein:
the method comprises, for the individual measurement gaps of the plurality of measurement gaps:
generating a random number; and
the determining whether to perform a measurement during the measurement gap includes comparing the random number to a threshold that is based on the measurement gap usage ratio.

11. The method of claim 1, wherein the method comprises, for at least one of the plurality of measurement gaps, and based on the result of the determining whether to perform a measurement during the measurement gap, causing the UE to transmit a signal on a physical random access channel (PRACH) during at least part of the measurement gap.

12. One or more non-transitory, computer-readable media having instructions that, when executed by one or more processors, cause a user equipment (UE) to:
obtain a first measurement of a signal received by the UE from a serving cell;
obtain a second measurement that is based on a plurality of neighbor cell measurements, each of the neighbor cell measurements being a measurement of a signal received by the UE from a respective one of a plurality of neighbor cells;
calculate a measurement gap usage ratio that is based on the first measurement and the second measurement; and
for individual measurement gaps of a plurality of measurement gaps, and based on the measurement gap usage ratio, determine whether to perform a measurement during the measurement gap,
wherein for at least one of the plurality of measurement gaps, and based on a result of the determination whether to perform a measurement during the measurement gap, the instructions, when executed by the one or more processors, further:
cause at least part of the UE to be in a low-power mode during at least part of the measurement gap;
cause a radio-frequency (RF) receiver of the UE to be powered down during at least part of the measurement gap; or
cause an RF transmitter of the UE to transmit a signal during at least part of the measurement gap.

13. The one or more non-transitory, computer-readable media of claim 12, wherein the first measurement is a serving cell quality measurement that indicates at least one of a reference signal received power (RSRP), reference signal received quality (RSRQ), or signal-to-interference-plus-noise ratio (SINR) of the signal received by the UE from the serving cell.

14. The one or more computer-readable media of claim 12, wherein the measurement gap usage ratio is inversely related to a difference between the first measurement and the second measurement.

15. The one or more computer-readable media of claim 12, wherein:
the instructions, when executed by the one or more processors, further cause the UE to select, based on the measurement gap usage ratio, a pattern from among a plurality of patterns; and
for the individual measurement gaps of the plurality of measurement gaps, the determination whether to perform a measurement during the measurement gap is based on the pattern.

16. The one or more computer-readable media of claim 12, wherein:
the instructions, when executed by the one or more processors, further cause the UE to generate, for the individual measurement gaps of the plurality of measurement gaps, a corresponding random number; and
the determination whether to perform a measurement during the measurement gap includes comparing the corresponding random number to a threshold that is based on the measurement gap usage ratio.

17. The one or more computer-readable media of claim 12, wherein, for at least one of the plurality of measurement gaps, and based on the result of the determination whether to perform a measurement during the measurement gap, the instructions, when executed by the one or more processors, further cause the UE to transmit a signal on a physical random access channel (PRACH) during at least part of the measurement gap.

18. A user equipment (UE) comprising:
processing circuitry to:
obtain a first measurement of a signal received by the UE from a serving cell;
calculate a measurement gap usage ratio that is based on the first measurement; and
for individual measurement gaps of a plurality of measurement gaps, and based on the measurement gap usage ratio, determine whether to perform a measurement during the measurement gap; and
memory coupled with the processing circuitry, the memory to store the measurement gap usage ratio,
wherein, for at least one of the plurality of measurement gaps, and based on a result of the determination whether to perform a measurement during the measurement gap, the processing circuitry is further to cause a radio-frequency (RF) receiver of the UE to be powered down during at least part of the measurement gap.

19. The UE of claim 18, wherein:
the processing circuitry is to select, based on the measurement gap usage ratio, a bitmap pattern; and
for the individual measurement gaps of the plurality of measurement gaps, the determination whether to perform a measurement during the measurement gap is based on a corresponding value of the bitmap pattern.

20. The UE of claim 18, wherein, for the individual measurement gaps of the plurality of measurement gaps:
the processing circuitry is to generate a corresponding random number; and
the determination whether to perform a measurement during the measurement gap includes comparing the corresponding random number to a threshold that is based on the measurement gap usage ratio.
